(19) United States
(12) Patent Application Publication
(10) Pub. No.: US 2023/0338818 A1
(43) Pub. Date: Oct. 26, 2023

(54) PERSONAL TRANSPORTATION APPARATUS

(71) Applicant: Daniel Baldwin, New South Wales (AU)

(72) Inventor: Daniel Baldwin, New South Wales (AU)

(21) Appl. No.: 18/025,895

(22) PCT Filed: Sep. 10, 2021
(86) PCT No.: PCT/AU2021/051050

§ 371 Date: Mar. 11, 2023

(30) Foreign Application Priority Data
Sep. 11, 2020 (AU) 2020903260

(51) Int. Cl. A63C 17/10; A63C 17/12; A63C 17/01

(52) U.S. Cl. CPC A63C 17/10; A63C 17/12; A63C 17/012

(57) ABSTRACT

A personal transportation apparatus (10) in the form of a motorised board (12) including a chassis (14) arranged to support a first foot support portion (16) and a second foot support portion (18) spaced apart from the first foot support portion (16), a first ground engaging arrangement (20) located proximate the first foot support portion (16), and a second ground engaging arrangement (22) located proximate the second foot support portion (18), the first and second ground engaging arrangements (20), (22) being adapted to at least one of slide, rotate and move over a ground surface. At least one of the first and second ground engaging arrangements (20, 22) may include a motive track assembly (24a, 24b) having a roller arrangement (26a, 26b) to rotatably support an endless track (28a, 28b), the roller arrangement (26a, 26b) including a motorised roller (30a, 30b) housing a motor internally of the motorised roller (30a, 30b) so as to drive the endless track (28a, 28b).

### RELATED APPLICATIONS

This application claims priority from Australian provisional patent application no. 2020903260 filed 11 Sep. 2020, the contents of which are incorporated by reference.

### TECHNICAL FIELD

The invention relates to a personal transportation apparatus. More specifically, the invention relates to a motorised board for personal transportation.

### BACKGROUND

Various types of motorised boards have been developed such as those including wheels and tracks. Such boards may include a body with foot support portions, and wheels or tracks supported by the body. The wheels or tracks may be coupled to the body via a mechanism that allows the motorised board to be steered by foot pressure such as by leaning from side to side. Motors may be provided in the form of electric or petrol motors that are coupled to the board and may drive the wheels or tracks by a pulley belt or other coupling. The motor may be controlled by a hand operable trigger or the like. In use, a rider balances on the board and users the trigger to control forward or rear movement, and may lean from side to side to steer the board.

A problem with existing boards relates to the configuration of the wheels or tracks, and in particular the motor, that may affect the centre of gravity of the board, the weight, aesthetic appearance and general usability of the board such as, for example, the motor obstructing the rider during use. Another problem relates to the control and usability of existing boards over rough surfaces and obstacles.

The invention disclosed herein seeks to overcome one or more of the above identified problems or at least provide a useful alternative.

### SUMMARY

In accordance with a first broad aspect there is provided, a motorised board for transportation of a person. The board may include a chassis arranged to support a first foot support portion, a second foot support portion spaced apart from the first foot support portion, a first ground engaging arrangement located proximate the first foot support portion, and a second ground engaging arrangement located proximate the second foot support portion, the first and second ground engaging arrangements adapted to at least one of slide, rotate and move over a ground surface. At least one of the first and second ground engaging arrangements may include a motive track assembly having a roller arrangement to rotatably support an endless track, the roller arrangement including a motorised roller housing a motor internally of the motorised roller so as to drive the endless track.

In an aspect, the roller arrangement includes an external roller located to engage an opposing side of the endless track relative to the motorised roller.

In another aspect, the endless track includes gripping elements and the external roller includes gaps to allow the passage of the gripping elements.

In yet another aspect, the endless track includes gripping elements and the external roller is adapted to engage with the endless track between at least some of the gripping elements.

In yet another aspect, the external roller is located adjacent to the motorised roller.

In yet another aspect, the motorised roller has a diameter larger than the external roller.

In yet another aspect, the motive track assembly incudes a roller chassis having opposing side supports and a first end and a second end, the motorised roller being located toward one of the first and second ends.

In yet another aspect, the roller chassis further includes a bridge member between the opposing side supports, the opposing side supports being curved and locating rollers of the roller assembly.

In yet another aspect, the bridge member supports and locates the external roller.

In yet another aspect, the motorised roller includes an at least partially hollow shaft between the motor and a shell of the roller.

In yet another aspect, the motorised roller includes a port to allow the passage of air to the motor.

In yet another aspect, the motorised roller includes a shell driven by the motor, the shell including a notch adapted to locate and drive the endless track.

In yet another aspect, both of the first and second ground engaging arrangements are respective first and second motive track assemblies, each with an independent one of the motorised roller in communication with a common controller.

In yet another aspect, the chassis includes suspension arrangement adapted to provide the first and second ground engaging arrangements at least some limited vertical movement relative to one another.

In yet another aspect, the chassis includes first and second lower members extending below the respective first and second foot support portions that couple to the first and second ground engaging arrangements, and an intermediate member coupled to the first and second lower members by the suspension arrangement.

In yet another aspect, the chassis further includes first and second upper members arranged to support the first and second foot support portions, the first and second foot support portions being coupled by the intermediate member, and wherein the first and second upper members extend generally parallel to and above the first and second lower members.

In yet another aspect, the first and second upper member are rigidly connected to one another by the intermediate member.

In yet another aspect, the first and second upper members are flexibly connected via a flexible element of the intermediate member.

### BRIEF DESCRIPTION OF THE FIGURES

The invention is described, by way of non-limiting example only, by reference to the accompanying figures, in which;

FIG. 1 is a top rear perspective view illustrating an apparatus in the form of a motorised board;

FIG. 2 is a top front perspective view illustrating the apparatus;

FIG. 3 is an underside rear perspective view illustrating the apparatus;

FIG. 4 is an underside front perspective view illustrating the apparatus;

FIG. 5 is a side view illustrating the apparatus;

FIG. 6 is an opposing side view illustrating the apparatus;

FIG. 7 is a top view illustrating the apparatus;

FIG. 8 is a bottom view illustrating the apparatus;

FIG. 9 is a front view illustrating the apparatus;

FIG. 10 is a rear view illustrating the apparatus; and

FIG. 11 is a sectional view illustrating a motorised roller to drive an endless track of the apparatus;

FIG. 12 is a top perspective view illustrating a second example of the apparatus;

FIG. 13 is another top perspective view illustrating the second example of the apparatus;

FIG. 14 is a bottom perspective view illustrating the second example of the apparatus;

FIGS. 15a and 15b are respective left hand and right hand side views illustrating the second example of the apparatus;

FIGS. 16a and 16b are respective top and bottom views illustrating the second example of the apparatus;

FIGS. 17a and 17b are respective back and front views illustrating the second example of the apparatus;

FIG. 18 is a side perspective view illustrating a third example of the apparatus; and

FIG. 19 is a rear perspective view illustrating a fourth example of the apparatus.

### DETAILED DESCRIPTION

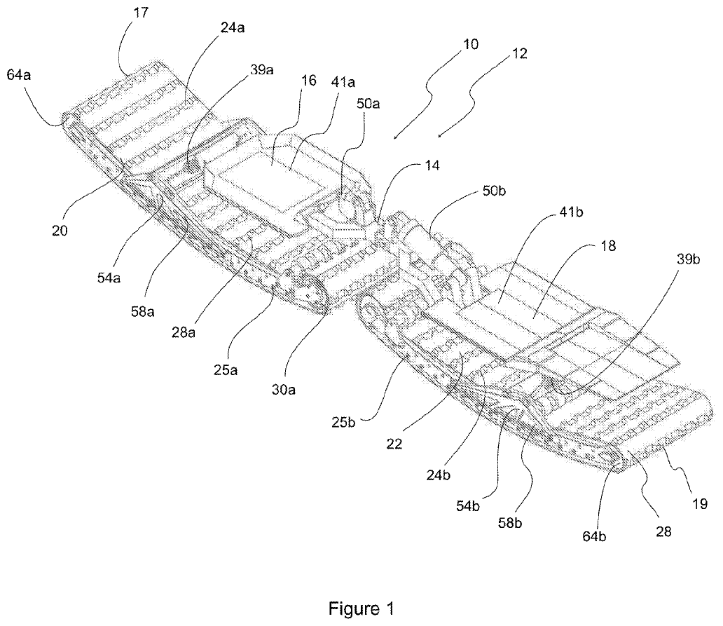

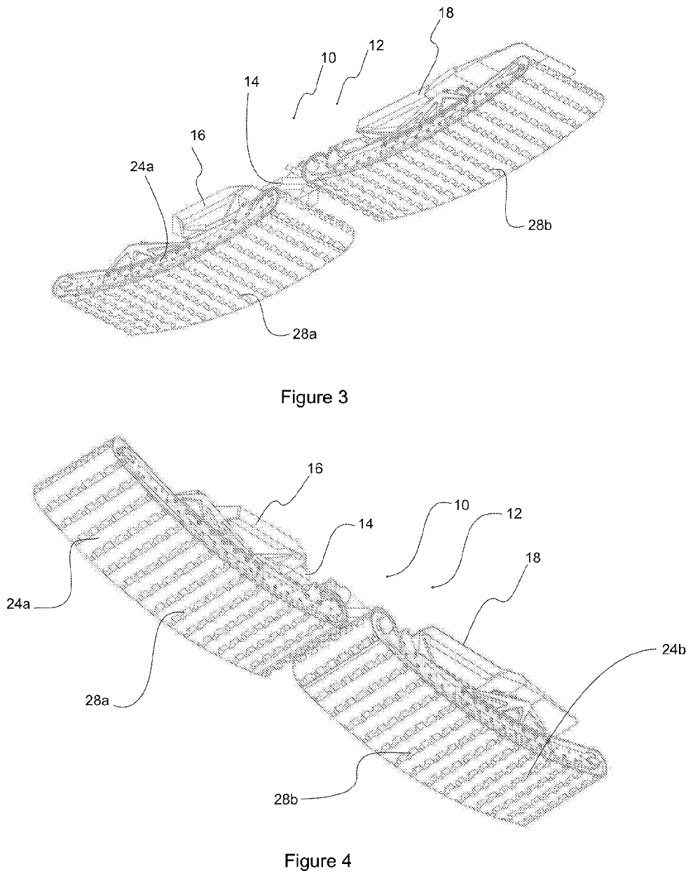

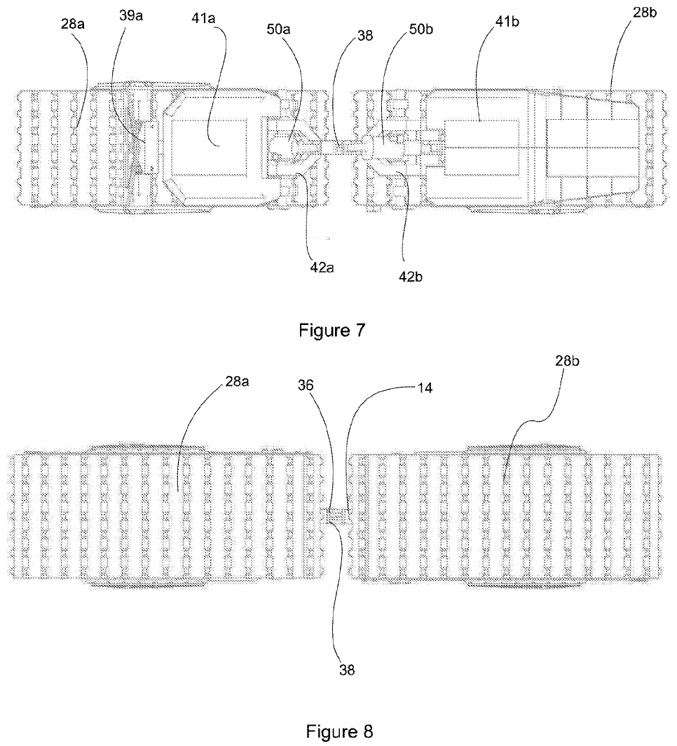

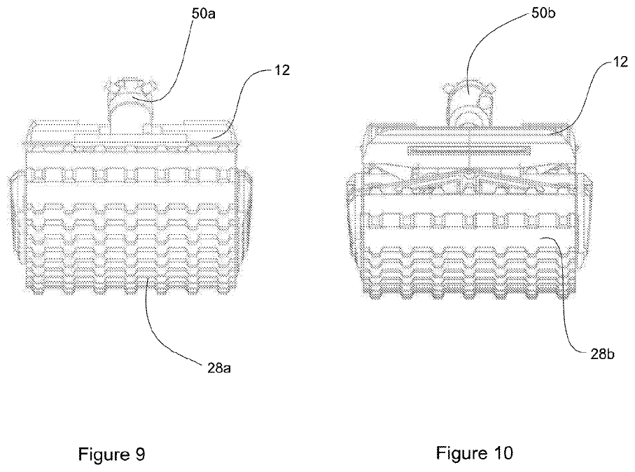

Referring to FIGS. 1 to 10, there is shown an example of a personal transportation apparatus or vehicle 10 in the form of a motorised board 12. The board 12 includes a chassis 14 arranged to support a first foot support portion 16 and a second foot support portion 18 spaced apart from the first foot support portion 16, a first ground engaging arrangement 20 located proximate the first foot support portion 16, and a second ground engaging arrangement 22 located proximate the second foot support portion 18, the first and second ground engaging arrangements 20, 22 being adapted to at least one of slide, rotate and move over a ground surface.

The first foot support portion 16 and the second foot support portion 18 may be separate foot pads or the like, as shown in this example, or may be portions of a continuous board extending between the feet of a user or rider. Both examples are contemplated herein. The first foot support portion 16 is preferably toward to front 17 of the board 12 and the second foot support 18 is preferably toward the rear 19 of the board 12. In this example, the first and second foot support portions 16, 18 may be about the same width, or wider, as a foot of a user and may be square or rectangular pads or platforms 41a, 41b. The rear 19 may have a mud guard 21b.

The first and second ground engaging arrangements 20, 22 may take various forms such as tracks, wheels or a ski. However, preferably, in this example, at least one of the first and second ground engaging arrangements 20, 22 include a respective first or second motive track assemblies 24a, 24b. Preferably, the second ground engaging arrangement 22 includes a second motive track assembly 24b and the first ground engaging arrangement 20 may be interchangeable to be, for example, a first motive track assembly 24a, or it may be a ski, wheels or the like.

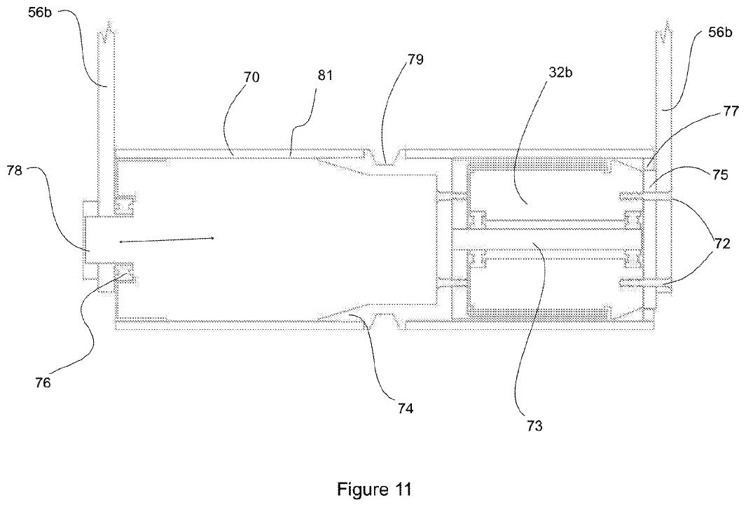

In this example, both of the first and second ground engaging arrangements 20, 22 include similar first and second motive track assemblies 24a, 24b and like numerals are used to denote like parts. The motive track assemblies 24a, 24b include respective roller arrangements 26a, 26b to rotatably support endless tracks 28a, 28b. The roller arrangements 26a, 26b may each include a motorised roller 30a, 30b housing motors 32a, 32b internally of the motorised roller 30a, 30b so as to drive the endless tracks 28a, 28b. An example of the motorised rollers 30a, 30b is best shown in FIG. 11. It is noted that in some examples, one of the motive track assemblies having 24a, 24b may omit the motorised roller or may include more than one of the motorised roller.

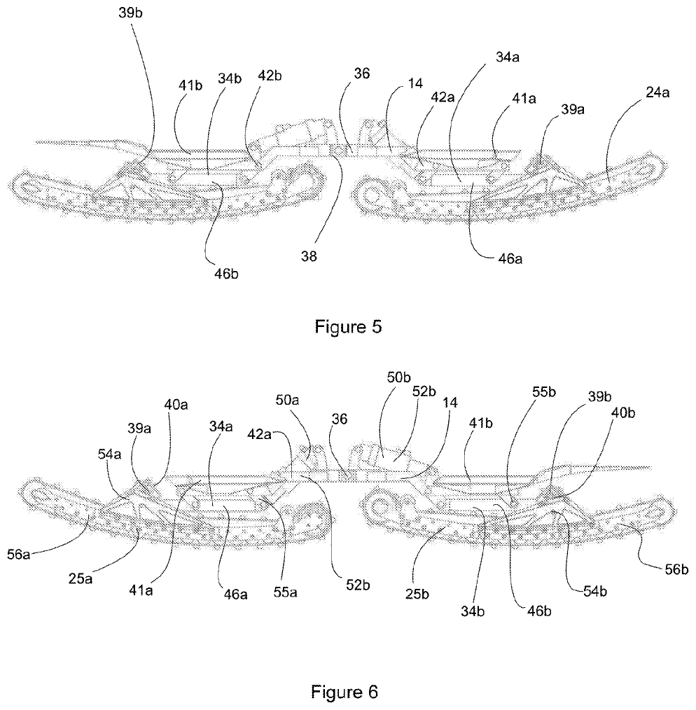

Turning to the chassis 14 in more detail, as best shown in FIGS. 5 and 6, the chassis 14 includes a first member arrangement 34a coupled to the first track assembly 24a, a second member arrangement 34b coupled to the second track assembly 24b, and an intermediate member 36 extending between and bridging the first member 34a and second member 34b. The intermediate member 36 may include a pivot 38, that may be damped, to allow movement between the first member 34a and the second member 34b. The first and second foot support portions 18, 20 are coupled generally atop the respective first and second member arrangements 34a, 34b.

The first and second member arrangements 34a, 34b are coupled to the first and second track assemblies 24a, 24b by moveable couplings 39a, 39b that each include one or more resilient elements 40a, 40b, that in this example are provided in the form of springs. Such moveable couplings 38a, 38b allow for relative lateral or yaw movement of the chassis 14 and the first and second track assemblies 24a, 24b so as to provide steering when a user or rider leans laterally on the board 12 applying foot pressure to the first and second foot support portions 18, 20.

In this example, the first and second member arrangements 34a, 34b each include upper or fork members 42a, 42b that are respectively located at or below the foot support platforms 41a and 41b of the first and second foot support portions 18, 20, and the folk members 42a, 42b are pivotally connected to lower members 46a, 46b of the first and second member arrangements 34a, 34b that extend and couple with the moveable couplings 39a, 39b of the first and second track assemblies 24a, 24b.

The coupling between the fork members 42a, 42b and the lower members 46a, 46b includes a suspension arrangement 50a, 50b that allows the first and second track assemblies 24a, 24b to undergo at least some vertical movement relative to the foot support platforms 41a and 41b. In this example, the suspension arrangement 50a, 50b includes respective first and second shocks 52a, 52b that may be air or oil shocks. The shocks 52a, 52b are connected between the intermediate member 36 and the lower members 46a, 46b with the foot support platforms 40a and 40b movably connected there above via linkages 55a, 55b thereby providing limited independent movement of the foot support platforms 40a and 40b.

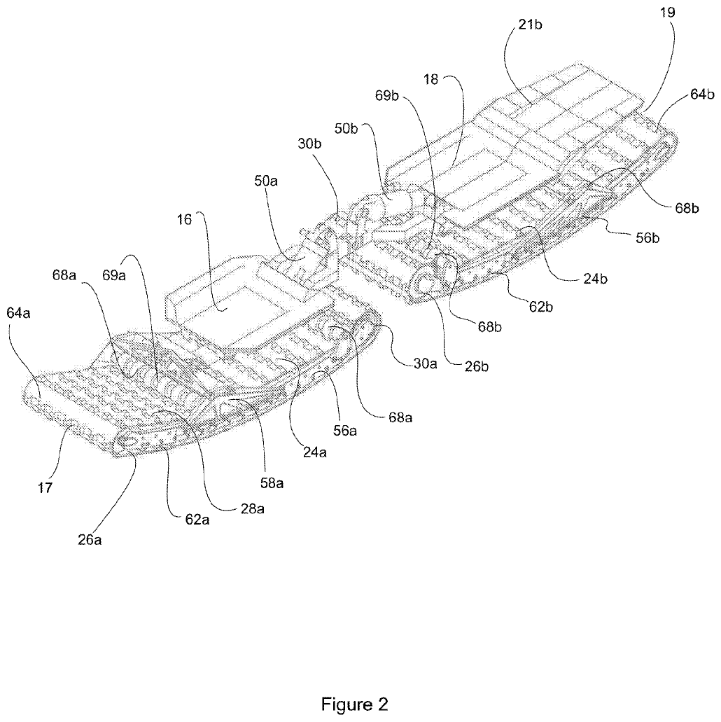

Turning now to the first and second track assemblies 24a, 24b in more detail, the first and second track assemblies 24a, 24b include a roller chassis 25a, 25b having bridge structures 54a, 54b, best shown in FIGS. 1 and 2, that extend between opposing side track support members 56a, 56b. The bridge structures 54a, 54b each centrally support the moveable couplings 39a, 39b above the endless tracks 28a, 28b. The bridge structures 54a, 54b include bridge sides 58a, 58b that couple to the opposing side support members 56a, 56b.

The track side support members 56a, 56b are curved in shape and define the profile of the endless tracks 28, 28b extending about the roller arrangements 26a, 26b. The roller arrangements 26a, 26b includes a plurality of guide rollers 62a, 62b that extend between the track support members 56a, 56b, the motorised roller 30a, 30b and end rollers 64a, 64b. The motorised roller 30a, 30b may be located toward either end of the roller chassis 25a, 25b but in this example are inwardly located toward the centre of the board 12.

The motorised roller 30a, 30b and end rollers 64a, 64b may have a diameter larger than the guide rollers 62a, 62b. The roller arrangements 26a, 26b each include external roller 68a, 68b located on an opposing side of the endless tracks 28a, 28b relative to the motorised roller 30a, 30b. The external rollers 68a, 68b are best shown in FIG. 2 and include gaps 69a, 69b between wheels thereof which allow the knobs or grip of the tracks 28a, 28b to pass the rollers 68a, 68b.

The external rollers 68a, 68b extend between the bridge sides 58a, 58b and is arranged to lower the profile or path of the endless tracks 28a, 28b to proceed generally under the chassis 14 and thereby allowing the overall height of the board 12, in particular the foot support portions 16, 18, to be lowered. This allows a user or rider to have a lower centre of gravity. In some examples there may be only one of the external rollers 68a, 68b per track assembly.

Referring now more specifically to FIG. 11, an example of the motorised roller 30b is shown in more detail. The motorised roller 30b includes a roller body 70 housing the motor 32b. The motor 32b is connected via fasteners 72 to the opposing side support member 56b and rotates a shaft 73 that drives hollow shaft 74 that in turn drives a shell 81 of the roller body 70. An inner fixed slip ring 75 and an outer slip ring 77 are located between the motor 32b and the support member 56b. The hollow shaft 74 is located at the opposing side support member 56b by a bearing 76 and an aperture or port 78 that allows the exchange or venting of air internally of the hollow shaft 74 to the motor 32b. The port 78 allows the passage of air or water to allow the purging of heat and/or contaminants. The hollow shaft 74 includes a notch 79, such as a V shaped annular notch, to locate and assist to drive the endless track 28b. The hollow shaft 74 may be formed as part of the motor 32b to simplify assembly.

The motor 32b may be in electrical communication, either wired and wirelessly, with a control system and battery (not shown) that may be housed by the chassis 14 such as under the foot support portions 16, 18 or intermediate thereof. The battery may be a replaceable battery pack, or the like, generally intermediate the board 12. The control system may include a microcontroller and an associated hand trigger that allows a user to control the speed and direction of the motor (or motors) and thus control the motion of the board 12, in use.

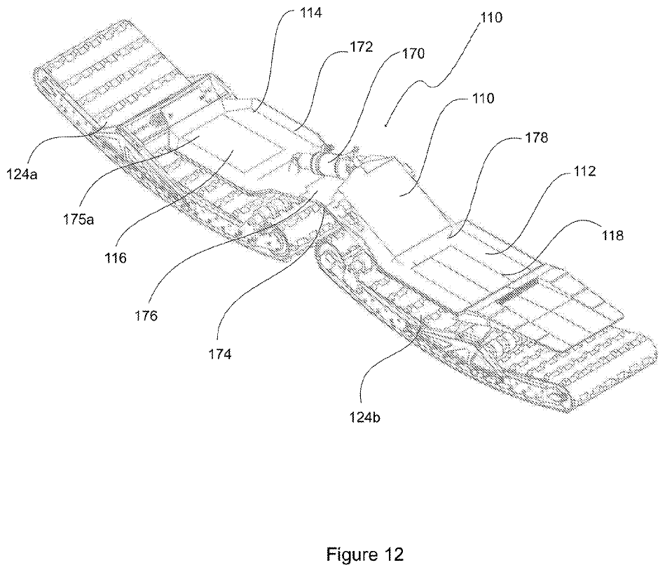

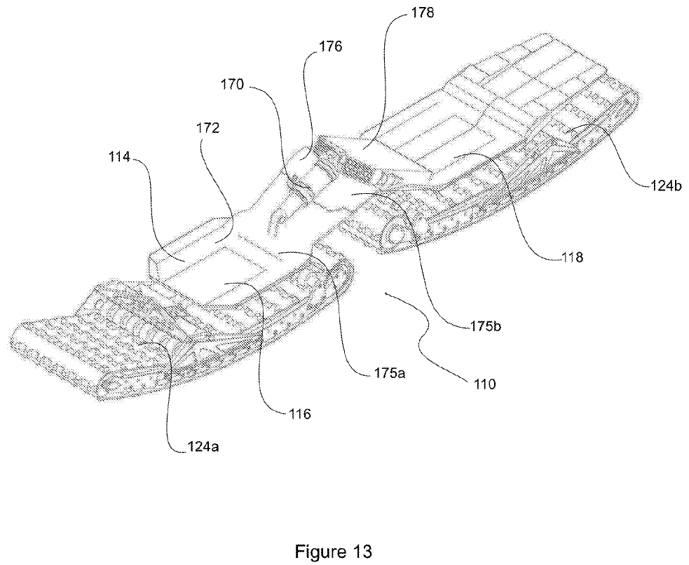

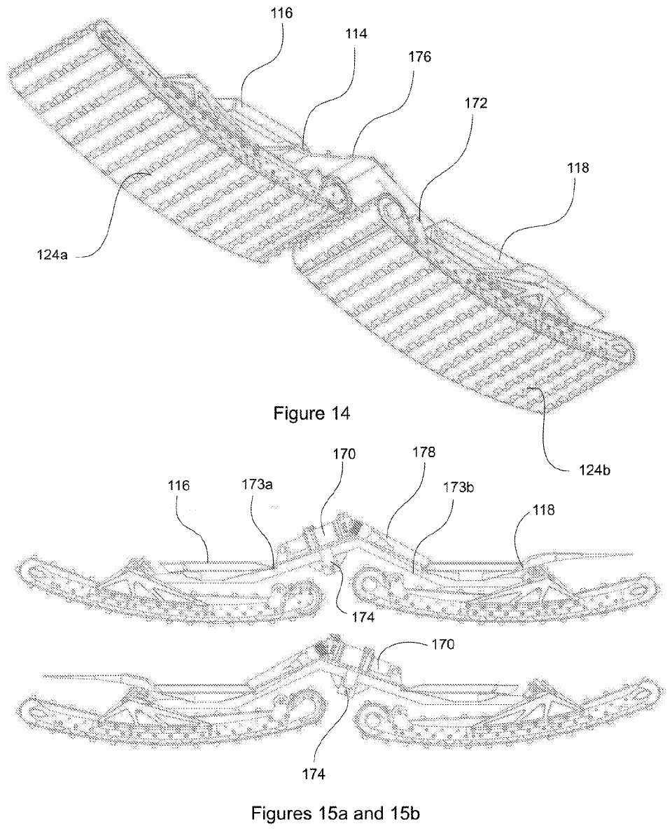

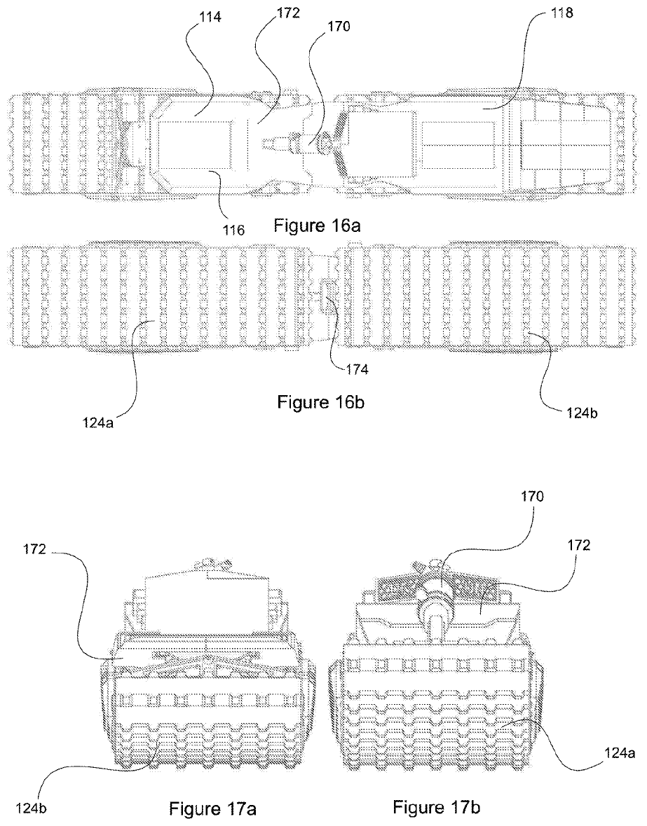

FIGS. 12 to 17b show a second example of the apparatus 110 in which like sequences of numerals denote like parts (i.e. 10, 110 etc). In this example, the apparatus 110 is largely similar to the first example, and the front and rear track assemblies 124a, 124b are the same. However, the arrangement of the chassis 114 has been modified to include a single shock 170, a two-part board 172 that has an intermediate pivot 174 between the first foot support portion 116 and the second foot support portion 118.

The two-part board 172 is supported by first and second chassis sections 173a, and 173b that meet at the pivot 174. The two-part board 172 has a first section 175a that overlaps with a second section 175b at an overlapping section 176. The second section 175b is above and overlaps the first section 175a.

The arrangement of the pivot 174, shock 170 and the overlapping section 176 restricts pivoting in one direction and may rely on flex, whereas the other direction may pivot and energise the single shock 170. The two-part board 172 may also include a housing 178 for a battery, control components and connectors such as for charging (not shown).

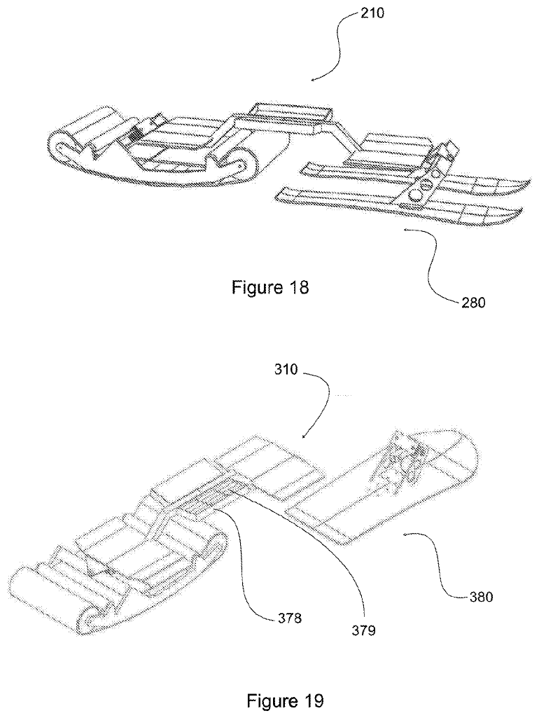

FIGS. 18 and 19 respectively show third and fourth examples of the apparatus 210, 310 which have alternative the first arrangements in the form of ski attachment 280 as shown in FIG. 18 and a snowboard attachment 380 as shown in FIG. 19. Other attachments are also contemplated such as an ice skate attachment, and the attachments may be interchangeable. A housing 378 with batteries 379 is shown in FIG. 19 intermediate of the apparatus 310.

Advantageously, there has been described a personal transportation apparatus in the form of a board that includes a track arrangement to allow a lower centre of gravity by having a motor mounting inside the roller and/or having an external roller lower the profile of the endless track. Further advantageously, the example of the board include suspension including front or dual front and rear suspension and a central pivot that improves the ride quality and usability of the board.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

The claims defining the invention are as follows:

1. A motorised board for transportation of a person, the board including a chassis arranged to support a first foot support portion, a second foot support portion spaced apart from the first foot support portion, a first ground engaging arrangement located proximate the first foot support portion, and a second ground engaging arrangement located proximate the second foot support portion, the first and second ground engaging arrangements adapted to at least one of slide, rotate and move over a ground surface, wherein at least one of the first and second ground engaging arrangements includes a motive track assembly having a roller arrangement to rotatably support an endless track, the roller arrangement including a motorised roller housing a motor internally of the motorised roller so as to drive the endless track.

2. The motorised board according to claim 1, wherein the roller arrangement includes an external roller located to engage an opposing side of the endless track relative to the motorised roller.

3. The motorised board according to claim 2, wherein the endless track includes gripping elements and the external roller includes gaps to allow the passage of the gripping elements.

4. The motorised board according to claim 2, wherein the endless track includes gripping elements and the external roller is adapted to engage with the endless track between at least some of the gripping elements.

5. The motorised board according to claim 2, wherein the external roller is located adjacent to the motorised roller.

6. The motorised board according to claim 5, wherein the motorised roller has a diameter larger than the external roller.

7. The motorised board according to claim 2, wherein the motive track assembly incudes a roller chassis having opposing side supports and a first end and a second end, the motorised roller being located toward one of the first and second ends.

8. The motorised board according to claim 7, wherein the roller chassis further includes a bridge member between the opposing side supports, the opposing side supports being curved and locating rollers of the roller assembly.

9. The motorised board according to claim 8, wherein the bridge member supports and locates the external roller.

10. The motorised board according to claim 1, wherein the motorised roller includes an at least partially hollow shaft between the motor and a shell of the roller.

11. The motorised board according to claim 1, wherein the motorised roller includes a port to allow the passage of a fluid such as water or air to the motor.

12. The motorised board according to claim 1, wherein the motorised roller includes a shell driven by the motor, the shell including a notch adapted to locate and drive the endless track.

13. The motorised board according to claim 1, wherein both of the first and second ground engaging arrangements are respective first and second motive track assemblies, each with an independent one of the motorised roller in communication with a common controller.

14. The motorised board according to claim 1, wherein the chassis includes suspension arrangement adapted to provide the first and second ground engaging arrangements at least some limited vertical movement relative to one another.

15. The motorised board according to claim 14, wherein the chassis includes first and second lower members extending below the respective first and second foot support portions that couple to the first and second ground engaging arrangements, and an intermediate member coupled to the first and second lower members by the suspension arrangement.

16. The motorised board according to claim 12, wherein the chassis further includes first and second upper members arranged to support the first and second foot support portions, the first and second foot support portions being coupled by the intermediate member, and wherein the first and second upper members extend generally parallel to and above the first and second lower members.

17. The motorised board according to claim 16, wherein the first and second upper member are rigidly connected to one another by the intermediate member.

18. The motorised board according to claim 16, wherein the first and second upper members are flexibly connected via a flexible element of the intermediate member.
